(19) United States
(12) Patent Application Publication
(10) Pub. No.: US 2015/0009205 A1
(43) Pub. Date: Jan. 8, 2015

(54) Method of Improving Ericsson Texture Compression 1 Image Quality

(71) Applicant: ArcSoft ( Hangzhou) Multimedia Technology Co., Ltd., Hangzhou City (CN)

(72) Inventor: Wei Wan, Hangzhou City (CN)

(21) Appl. No.: 13/934,241

(22) Filed: Jul. 3, 2013

(51) Int. Cl. G06T 9/00; G06T 19/20

(52) U.S. Cl. CPC G06T 9/00; G06T 19/20
USPC 345/419

(57) ABSTRACT

A method of improving Ericsson Texture Compression image quality includes providing an original image in the RGB color space, performing an image dithering process on the original image to produce a dithered image, and performing an Ericsson Texture Compression process on the dithered image to produce a compressed image.

### BACKGROUND OF THE INVENTION

1. Field of the Invention

The invention relates to Ericsson Texture Compression, and more particularly to a method of performing a dithering process on images before performing an Ericsson Texture Compression 1 process for improving the quality of resulting images.

2. Description of the Prior Art

The original version of the Ericsson Texture Compression (ETC) compression scheme is referred to as Ericsson Texture Compression 1 (ETC1), and was first developed in 2005. The ETC1 compression scheme compresses 24-bit RGB data by a factor of six. In 24-bit RGB data, eight bits of data are allocated for each of the red, green, and blue colors, which adds up to 24 bits in total.

The ETC1 compression scheme takes 4×4 groups of 24-bit pixel data and compresses each group into a single 64-bit word, thereby compressing the pixel data to be one-sixth of its original size.

However, the quality resulting from ETC1 compression is not good enough for images in many applications. There exists a need for an improved method of using ETC1 compression which produces higher quality images.

### SUMMARY OF THE INVENTION

It is therefore one of the primary objectives of the claimed invention to provide an improved method for performing Ericsson Texture Compression.

According to an exemplary embodiment of the claimed invention, a method of improving Ericsson Texture Compression image quality is disclosed. The method includes providing an original image in the RGB color space, performing an image dithering process on the original image to produce a dithered image, and performing an Ericsson Texture Compression process on the dithered image to produce a compressed image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image compressing device according to the present invention.

FIG. 2 is a flowchart describing the method of compressing the original image file to become the resulting compressed image according to the present invention.

FIG. 3 shows a comparison of the original image file, a compressed image according to the prior art method of using ETC1 encoding, and the resulting compressed image according to the present invention method of using ETC1 encoding.

### DETAILED DESCRIPTION

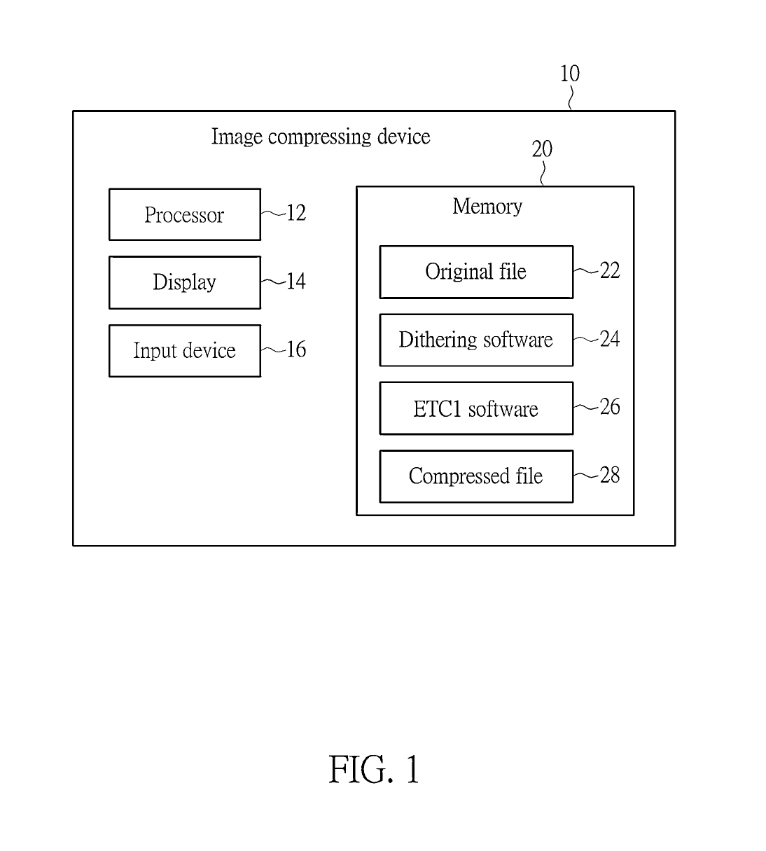

Please refer to FIG. 1. FIG. 1 is a functional block diagram of an image compressing device 10 according to the present invention. The image compressing device 10 contains a processor 12 for executing software commands and controlling operation of the image compressing device 10. A memory 20 stores an original image file 22, dithering software 24, ETC1 compression software 26, as well as a resulting compressed image 28. The image compressing device 10 also may contain an optional display 14 for showing the original image file 22 or the resulting compressed image 28, and an input device 16 for allowing a user to control the image compressing device 10. The original image file 22 will be operated on by the dithering software 24 for performing a dithering process. The dithered image will then be operated on by the ETC1 compression software 26 for performing an ETC1 process on the dithered image to produce the resulting compressed image 28.

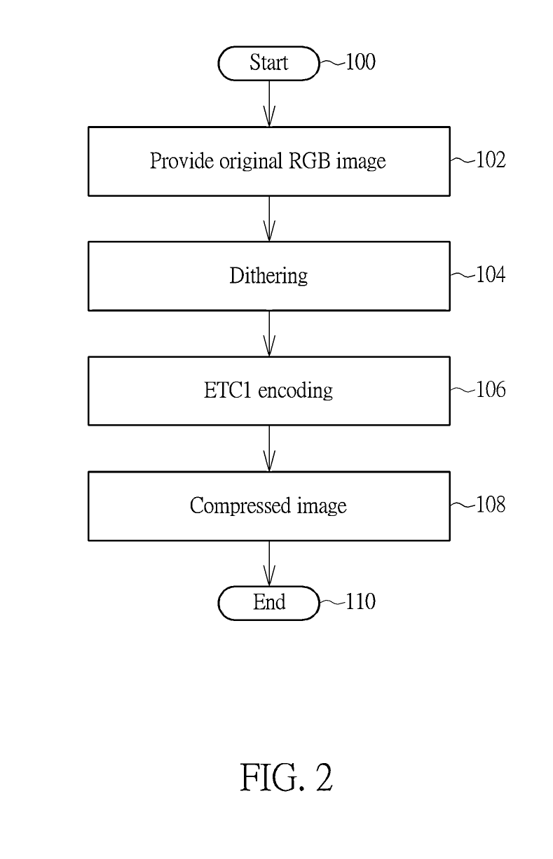

Please refer to FIG. 2. FIG. 2 is a flowchart describing the method of compressing the original image file 22 to become the resulting compressed image 28 according to the present invention. Steps in the flowchart will be explained as follows.

Step 100: Start.

Step 102: The original image file 22 is provided to the image compressing device 10 by the user of the image compressing device 10. The original image file 22 is an RGB image. In a preferred embodiment, the original image file 22 is a 24-bit RGB image.

Step 104: A dithering process is performed on the original image file 22 by the dithering software 24 to produce a dithered image.

Step 106: An ETC1 encoding process is performed on the dithered image to produce the resulting compressed image 28.

Step 108: The resulting compressed image 28 is produced and output by the image compressing device 10.

Step 110: End.

Differing from the conventional method of performing ETC1 encoding on an image, the present invention first performs the dithering process, which is used to create the illusion of color depth in the dithered image. By first performing the dithering process on the original image file 22 before the dithered image is compressed using the ETC1 encoding process, the resulting compressed image 28 much more closely resembles the original image file 22 than would be the case if the dithering process was not used.

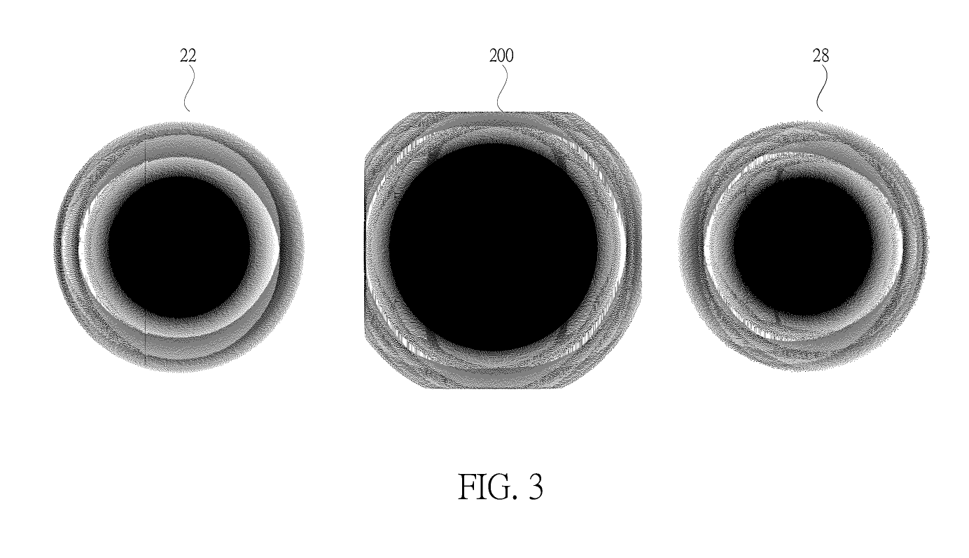

Please refer to FIG. 3. FIG. 3 shows a comparison of the original image file 22, a compressed image 200 according to the prior art method of using ETC1 encoding, and the resulting compressed image 28 according to the present invention method of using ETC1 encoding. As can be seen, the resulting compressed image 28 more closely resembles the original image file 22 than does the compressed image 200 according to the prior art method of using ETC1 encoding. Thus, the additional dithering process performed by the dithering software 24 before the ETC1 encoding process is performed by the ETC1 compression software 26 produces better end results for the resulting compressed image 28.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of improving Ericsson Texture Compression image quality, the method comprising:
providing an original image in the RGB color space;
performing an image dithering process on the original image to produce a dithered image; and
performing an Ericsson Texture Compression process on the dithered image to produce a compressed image.

2. The method of claim 1, wherein the Ericsson Texture Compression process is an Ericsson Texture Compression 1 process.
